(19) United States
(12) Patent Application Publication
(10) Pub. No.: US 2025/0125482 A1
(43) Pub. Date: Apr. 17, 2025

(54) BATTERY CELL AND ENERGY STORAGE MODULE INCLUDING THE SAME

(71) Applicant: Samsung SDI Co., Ltd., Yongin-si (KR)

(72) Inventor: Seon Yeong KANG, Yongin-si (KR)

(21) Appl. No.: 18/651,065

(22) Filed: Apr. 30, 2024

(30) Foreign Application Priority Data
Oct. 17, 2023 (KR) 10-2023-0138458

(51) Int. Cl. H01M 50/383; H01M 50/209; H01M 50/489

(52) U.S. Cl. CPC H01M 50/383; H01M 50/489; H01M 50/209

(57) ABSTRACT

A battery cell includes: an electrode assembly including a positive electrode plate, a negative electrode plate, and a separator between the positive electrode plate and the negative electrode plate; a case accommodating the electrode assembly; a cap plate sealing an opening in the case; an electrode terminal electrically connected to the electrode assembly and protruding outside of the cap plate; and an extinguishing sheet inside the case and configured to impede propagation of fire.

### CROSS-REFERENCE TO RELATED APPLICATION

The present application claims priority to and the benefit of Korean Patent Application No. 10-2023-0138458, filed on Oct. 17, 2023, in the Korean Intellectual Property Office, the entire disclosure of which is incorporated herein by reference.

### BACKGROUND

### 1. Field

Aspects of embodiments of the present disclosure relate to a battery cell and an energy storage module including the same.

### 2. Description of the Related Art

An energy storage module is often associated with renewable energy, such as solar cells and a power system, and is configured to store power when a load's power demands are low and then use the stored power when the load's power demands are high. Thus, an energy storage module may refer to a device that includes a large number of battery cells (e.g., secondary battery cells).

In addition, battery cells used in electric vehicles are a main (or primary) power source for the electric vehicles and are used to store electrical energy. In addition, an electric motor operates by electricity supplied from the electric vehicle's battery cells to drive the electric vehicle. The performance and driving range of the electric vehicles depends on the quality, capacity, and management method of the battery cells.

Generally, a plurality of battery cells are stored in a plurality of trays, the plurality of trays are stored in a plurality of racks, and the plurality of racks are stored in a container box.

There have been instances of fires occurring in the energy storage module, and due to the nature of the energy storage module, if a fire occurs, it is not easy to extinguish. Because the energy storage module is constituted by the plurality of battery cells, the energy storage module generally has high capacity and high output, and thus, technologies for improving safety are being researched.

The above-described information disclosed in the Background section is for improving understanding of the background of the present disclosure and may include information that does not constitute prior (or related) art.

### SUMMARY

Embodiments of the present disclosure provide a battery cell exhibiting a reduced risk of fire and which can reduce or minimizing propagation of fire between adjacent battery cells to further improve safety. Embodiments of the present disclosure also provide an energy storage module including the battery cell as described above.

However, aspects and features of the present disclosure are not limited to the above-mentioned aspects and features, and other aspects and features not mentioned can be clearly understood by those skilled in the art from the description of the present disclosure, provided below.

According to an embodiment of the present disclosure, a battery cell includes:

an electrode assembly including a positive electrode plate, a negative electrode plate, and a separator between the positive electrode plate and the negative electrode plate; a case accommodating the electrode assembly; a cap plate sealing an opening in the case; an electrode terminal electrically connected to the electrode assembly and protruding outside of the cap plate; and an extinguishing sheet inside the case and configured to impede propagation of fire.

The extinguishing sheet may be inserted into the electrode assembly.

The extinguishing sheet may be a panel.

The electrode assembly may include: a first electrode assembly including a first side tab electrically connected to the electrode terminal; and a second electrode assembly stacked on the first electrode assembly and including a second side tab electrically connected to the electrode terminal. The extinguishing sheet may be arranged between the first electrode assembly and the second electrode assembly.

The first side tab may be at each of both sides of the first electrode assembly in a longitudinal direction.

The electrode assembly may include: a first electrode assembly including a first multi-tab electrically connected to the electrode terminal; and a second electrode assembly on a side surface of the first electrode assembly facing the first electrode assembly and including a second multi-tab electrically connected to the electrode terminal. The extinguishing sheet may be arranged between the first electrode assembly and the second electrode assembly.

The first multi-tab and the second multi-tab may protrude toward the cap plate.

In the electrode assembly, the positive electrode plate, the negative electrode plate, and the separator may be alternately stacked, and the extinguishing sheet may a plate and may be stacked such that it faces at least one of the positive electrode plate, the negative electrode plate, or the separator.

The extinguishing sheet may include at least one of a flame retardant, a nonflammable, or an insulating material.

According to another embodiment of the present disclosure. an energy storage module includes: a module case having a mounting space therein; and a plurality of battery cells arranged inside the module case. Each of the battery cells includes: an electrode assembly including a positive electrode plate, a negative electrode plate, and a separator between the positive electrode plate and the negative electrode plate; a case accommodating the electrode assembly; a cap plate sealing an opening in the case; an electrode terminal electrically connected to the electrode assembly and protruding to the outside of the cap plate; and an extinguishing sheet inside the case and configured to impede propagation of fire.

The extinguishing sheet may be inserted into the electrode assembly.

The electrode assembly may include: a first electrode assembly including a first side tab electrically connected to the electrode terminal; and a second electrode assembly stacked on the first electrode assembly and including a second side tab electrically connected to the electrode terminal. The extinguishing sheet may be arranged between the first electrode assembly and the second electrode assembly.

The first side tab may be provided at each of both sides of the first electrode assembly in a longitudinal direction, and the second side tab may be provided at each of both sides of the second electrode assembly in a longitudinal direction.

The electrode assembly may include: a first electrode assembly including a first multi-tab electrically connected to the electrode terminal; and a second electrode assembly on a side surface of the first electrode assembly facing the first electrode assembly and including a second multi-tab electrically connected to the electrode terminal. The extinguishing sheet may be arranged between the first electrode assembly and the second electrode assembly.

The first multi-tab and the second multi-tab may protrude toward the cap plate.

In the electrode assembly, the positive electrode plate, the negative electrode plate, and the separator may be alternately stacked, and the extinguishing sheet may be a plate and may face at least one of the positive electrode plate, the negative electrode plate, or the separator.

The extinguishing sheet may include at least one of a flame retardant, a nonflammable, or an insulating material.

The extinguishing sheet may be a panel.

The extinguishing sheet may include an extinguishing agent.

The extinguishing agent may include at least one of fluorine carbon, fluorine chlorine carbon, fluorine bromine carbon, fluorine iodine carbon, or halogenated carbon.

### BRIEF DESCRIPTION OF THE DRAWINGS

The following drawings attached to this specification illustrate embodiments of the present disclosure and are included to provide a further understanding of the aspects and features of the present disclosure, in conjunction with the detailed description. Thus, the present disclosure should not be construed as being limited to embodiments illustrated in the drawings:

FIG. 1 is a perspective view of an energy storage module according to an embodiment;

FIG. 2 is an exploded perspective view of the energy storage module shown in FIG. 1;

FIG. 3 is a perspective view of a state in which a battery cell and an insulating spacer are disposed on a lower plate in the energy storage module shown in FIG. 1;

FIG. 4 is a perspective view of the battery cell shown in FIG. 3 according to an embodiment;

FIG. 5 is a cross-sectional view of the battery cell shown in FIG. 4 according to an embodiment;

FIG. 6 is a perspective view of the battery cell and an extinguishing sheet according to an embodiment;

FIG. 7 is an exploded perspective view of the extinguishing sheet shown in FIG. 6 according to an embodiment;

FIG. 8 is a cross-sectional view of the extinguishing sheet shown in FIGS. 6 and 7;

FIG. 9 is a front view of the battery cell and the extinguishing sheet shown in FIG. 6;

FIG. 10 is a perspective view of a state in which the battery cell and the extinguishing sheet are inserted into a case according to an embodiment;

FIG. 11 is an exploded perspective view of a battery cell according to another embodiment;

FIG. 12 is a cross-sectional view of the battery cell shown in FIG. 11; and

FIG. 13 is a perspective view of stacked electrode assemblies with an extinguishing sheet installed between the electrode assemblies according to an embodiment.

### DETAILED DESCRIPTION

Hereinafter, embodiments of the present disclosure will be described, in detail, with reference to the accompanying drawings. Accordingly, it should be apparent to those skilled in the art that the following description of embodiments of the present disclosure is provided for illustration purposes and not to limit the present disclosure, which is defined by the appended claims and their equivalents. Thus, because the embodiments described in this specification and the configurations shown in the drawings are merely some embodiments of the present disclosure and do not represent all of the embodiments, and aspects and features thereof, of the present disclosure. It should be understood that there may be various equivalents and modifications that can be substituted for them at the time of this application.

The terms used in the following description and claims are not limited to their dictionary meanings but are used to enable a clear and consistent understanding of the present disclosure.

The reference to two objects being “the same” means “substantially the same.” Substantially the same may include a deviation that is considered to a low level in the art, for example, a deviation of less than 5%. In addition, uniformity of a parameter on a certain area may mean uniformity from an average perspective.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A battery cell and an energy storage module include the battery cell, according to embodiments, will be described hereinafter with reference to the drawings.

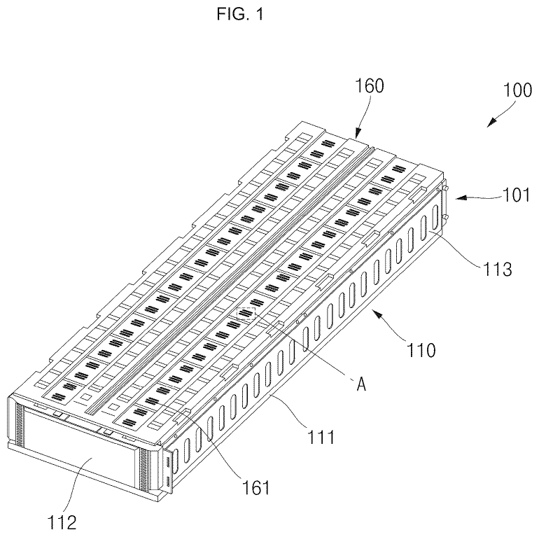

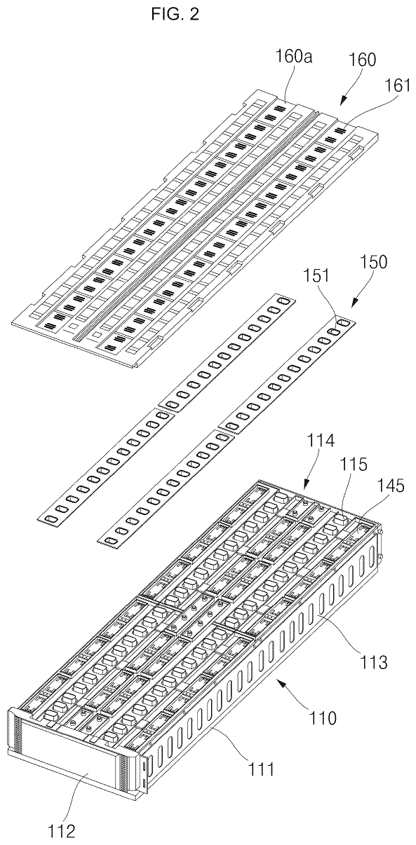

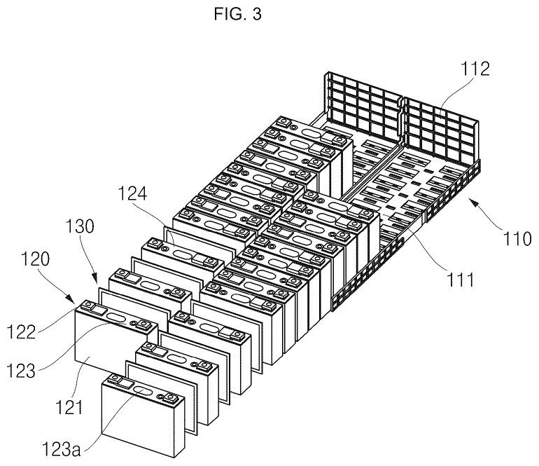

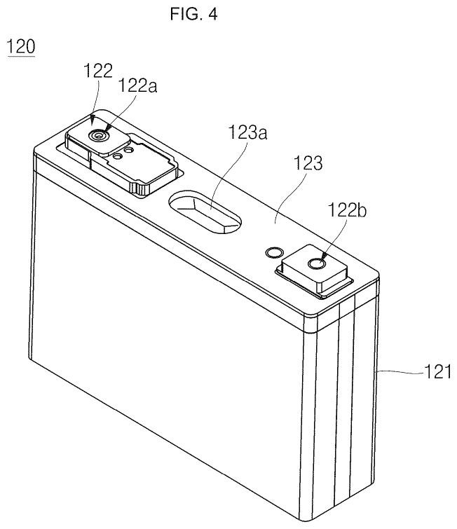

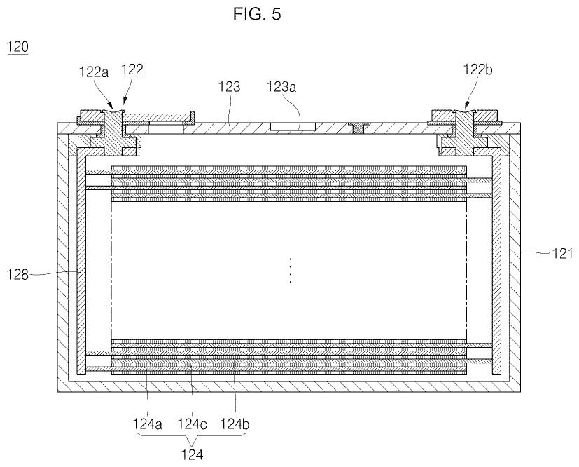

FIG. 1 is a perspective view of an energy storage module 100 according to an embodiment, FIG. 2 is an exploded perspective view of the energy storage module 100 shown in FIG. 1, FIG. 3 is a perspective view of a state in which a battery cell 120 and an insulating spacer 130 are disposed on a lower plate 111 of the energy storage module 100 according to an embodiment, FIG. 4 is a perspective view of the battery cell 120 according to an embodiment, and FIG. 5 is a cross-sectional view of the battery cell 120 shown in FIG. 4;

As illustrated in FIGS. 1 to 3, an energy storage module 100, according to an embodiment, may include a module case 101, a battery cell 120, an insulating spacer 130, a busbar 145, an inner sheet 150, and an upper cover 160.

The module case 101 may include a cover member 110 and an upper plate 114. The cover member 110 may provide a space that accommodates the battery cell 120 and the insulating spacer 130. The cover member 110 may include a lower plate 111, an end plate 112, and a side plate 113, and a space in which the battery cell 120 and the insulating spacer 130 is to be disposed (or accommodated) may be provided inside the cover member 110. In some embodiments, the cover member 110 may fix positions of the battery cell 120 and the insulating spacer 130 and may protect the battery cell 120 from an external impact, etc.

The insulating spacer 130 may be interposed between adjacent ones of the battery cells 120 to prevent the battery cells 120 from contacting each other, and thus, each battery cell 120 (e.g., each housing or case of each battery cell 120) may be maintained in electrical independence (or electrical isolation). In some embodiments, because the insulating spacer 130 is installed so that the battery cell 120 and an adjacent battery cell 120 are maintained at (e.g., are spaced apart at) an interval, a passage for external air or a moving path for an extinguishing agent may be provided to cool the battery cells 120. The insulating spacer 130 may be formed by mixing (or including) a flame retardant or nonflammable sheet that is configured to prevent a flame from propagating if fire occurs in the battery cell 120 and an insulating sheet that prevents heat from being transferred between adjacent ones of the battery cells 120.

If the extinguishing agent is applied from an upper side of the insulating spacer 130, the extinguishing agent may move downwardly along a surface of the insulating spacer 130. Therefore, the extinguishing agent may contact the case 121 of the battery cell 120 to cool the battery cell 120 as well to extinguish a fire in the battery cell 120.

The upper plate 114 may be coupled to an upper portion (or upper end) of the cover member 110. The upper plate 114 may be coupled to the cover member 110 while covering an upper portion of the battery cell 120. In some embodiments, each of a first electrode terminal 122a and a second electrode terminal 122b of the battery cell 120 (see, e.g., FIGS. 4 and 5) may be exposed at an upper portion of the upper plate 114, and the busbar 145 may be coupled to each terminal, and thus, the battery cells 120 may be connected to each other in series, parallel, or series-parallel.

The upper plate 114 may include a duct 115 corresponding to a vent 123a defined in a top surface of each of the plurality of battery cells 120. The duct 115 may be arranged in plurality in one direction, for example, in a longitudinal direction. In some embodiments, a gas discharged through the vent 123a in the battery cell 120 may move upwardly along (e.g., through) the duct 115 in the upper plate 114.

The inner sheet 150 may be disposed between the upper plate 114 and the top cover 160. The inner sheet 150 may be provided as at least one member extending along one direction, for example, the longitudinal direction of the upper plate 114. In some embodiments, the inner sheet 150 may have an opening hole (e.g., an opening) 151 at a position corresponding to the duct 115 in the upper plate 114. In some embodiments, the inner sheet 150 may be disposed so that the opening hole 151 matches (e.g., is aligned with) the duct 115 in the upper plate 114. The inner sheet 150 is coupled to a lower portion of the upper cover 160, and thus, the inner sheet 150 may be disposed above the upper plate 114.

The top cover 160 may be coupled to the upper portion of the upper plate 114. The upper cover 160 may cover the upper plate 114 and the busbar 145. In some embodiments, the inner sheet 150 may be mounted on a bottom surface of the upper cover 160. In some embodiments, the upper cover 160 may have a discharge hole (e.g., a discharge opening) 161 that defines a hole (or opening) in a cover top surface 160a. The discharge hole 161 may be arranged in plurality in one direction, for example, the longitudinal direction of the upper cover 160. The discharge hole 161 may be defined at a position corresponding to the duct 115 in the upper plate 114. A gas discharged by operation of the vent 123a in the battery cell 120 may be discharged to the outside through the duct 115 in the upper plate 114 and the discharge hole 161 in the upper cover 160.

Referring to FIGS. 4 and 5, the battery cell 120 may have a configuration in which an electrode assembly 124 is accommodated in the case 121 and a cap plate 123 covers an upper portion of the case 121. In some embodiments, the vent 163 may be provided at approximately a center of the cap plate 123 and may be a portion of the cap plate 123 that has a relatively thin thickness compared to other areas thereof. The duct 115 in the upper plate 114 may be disposed corresponding to (e.g., may be aligned with) an upper portion of the vent 123a.

In some embodiments, the electrode assembly 124 may be electrically connected to the electrode terminal 122 at the upper portion of the cap plate 123 through a pair of current collectors 128.

The electrode assembly 124 may include a negative electrode plate 124a, a positive electrode plate 124b disposed to be opposite to the negative electrode plate 124a, and a separator 124c disposed between the negative electrode plate 124a and the positive electrode plate 124b. The electrode assembly 124 may be accommodated in the case 121 together with an electrolyte.

The electrode assembly 124 may be a winding, stacking, or laminating type electrode assembly in which the separator 124c is disposed between the positive electrode plate 124b and the negative electrode plate 124a. The positive electrode plate 124b and the negative electrode plate 124a are coated with the active material at a coating portion. In some embodiments, in the battery cell 120, the electrode terminal 122 that is electrically connected to areas of the positive electrode plate 124b and the negative electrode plate 124a at where the active material is not applied, for example, a non-coating portion of the positive electrode plate 124b and the negative electrode plate 124a that exposed at sides (e.g., opposite sides) of the electrode assembly 124. The electrode terminal 122 may include a first electrode terminal 122a and a second electrode terminal 122b, which are a negative electrode terminal and a positive electrode terminal, respectively. In some embodiments, however, the first electrode terminal 122a and the second electrode terminal 122b may be positive and negative electrode terminals, respectively.

The electrode assembly 124 may be provided by winding or stacking a stack of the negative electrode plate 124a, the separator 124c, and the positive electrode plate 124b, which are provided as a thin plate or film. When the electrode assembly 124 is the wound stack type electrode assembly, a winding axis may be parallel to the longitudinal direction of the case 121. In some embodiments, the electrode assembly 124 may be a stack type rather than a winding type electrode assembly, but the shape of the electrode assembly 124 is not limited in the present disclosure. In some embodiments, the electrode assembly 124 may be a Z-stack electrode assembly 124 in which the positive electrode plate 124b and the negative electrode plate 124a are inserted into both sides of the separator 124c, which is bent into a Z-stack. In some embodiments, the electrode assembly 124 may be stacked so that a plurality of electrode assemblies 124 are adjacent to each other and accommodated in the case 121. The number of electrode assemblies 124 is not limited in the present disclosure. The negative electrode plate 124a of the electrode assembly 124 may act as a negative electrode, and the positive plate 124b may act as a positive electrode, and vice versa.

The negative electrode plate 124a may be formed by applying a first electrode active material, such as graphite or carbon, to a first electrode current collector made of a metal foil, such as copper, a copper alloy, nickel, or a nickel alloy. The negative electrode plate 124a may include a first electrode tab (e.g., first non-coating portion) that is not coated with the first electrode active material. The first electrode tab may act as a path for a current flow between the negative electrode plate 124a and the current collector 128. In some embodiments, the first electrode tab may be provided by being cut in advance to protrude to one side when the negative electrode plate 124a is manufactured and may protrude more to one side than (e.g., may protrude beyond) the separator 124c without separate cutting. In some embodiments, a plurality of first electrode tabs may gathered together and tack-welded, and a first current collector may be welded to the tack-welded first electrode tabs to be coupled together.

The positive electrode plate 124b may be provided by applying a second electrode active material, such as transition metal oxide, to a second electrode collector made of metal foil, such as aluminum or an aluminum alloy. The positive electrode plate 124b may include a second electrode tab (e.g., second non-coating portion) that is not coated with the second electrode active material. The second electrode tab may act as a path for a current flow between the positive electrode plate 124b and the current collector 128. In some embodiments, the second electrode tab may be provided by being cut in advance to protrude to the other side when the positive electrode plate 124b is manufactured and may protrude more to the other side than (e.g., may protrude beyond) the separator 124c without separate cutting. In some embodiments, the plurality of second electrode tabs may gathered together and tack-welded, and a second current collector may be welded to the tack-welded second electrode tabs to be coupled together.

In some embodiments, the first electrode tab may be disposed on a side surface at a left end of the electrode assembly 124, and the second electrode tab may be disposed on a side surface at a right end of the electrode assembly 124 or may disposed on one surface in the same direction.

The first electrode tab of the negative electrode plate 124a and the second electrode tab of the positive electrode plate 124b may be disposed at both ends of the electrode assembly 124, respectively, as described above. In some embodiments, the electrode assembly 124 may be accommodated in the case 121 together with the electrolyte. In some embodiments, the electrode assembly 124 may be respectively provided with the current collector 128, and the current collector 128 may be connected to the first electrode tab of the negative electrode plate 124a and the second electrode tab of the positive electrode plate 124b, which are exposed at both sides of the electrode assembly 124.

In some embodiments, the separator 124c may be disposed between the negative electrode plate 124a and the positive electrode plate 124b to prevent short circuit and enable movement of lithium ions and may include polyethylene, polypropylene, or a composite film of polyethylene and polypropylene. In some embodiments, the separator 124c may be replaced with an inorganic solid electrolyte, such as a sulfide, an oxide, or a phosphate compound that does not require a liquid or gel electrolyte.

In some embodiments, the electrolyte may include an organic solvent, such as EC, PC, DEC, EMC, or DMC, and lithium salt, such as LiPF₆ or LiBF₄. In some embodiments, the electrolyte may be a liquid or gel. In some embodiments, when an inorganic-based solid electrolyte is used, the electrolyte may be omitted.

The first electrode terminal 122a may be made of a metal and may be electrically connected to the negative electrode plate 124a through the current collector 128. The second electrode terminal 122b may be made of a metal and may be electrically connected to the positive electrode plate 124b through the current collector 128.

The case 121 may have a hollow rectangular parallelepiped shape with an opening in an upper portion thereof. The electrode assembly 124 may be inserted into the case 121 through the opening.

The cap plate 123 may seal the opening in the case 121 and may be made of the same material as that of the case 121. In one embodiment, the cap plate 123 may be coupled to the case 121 by laser welding, but the present disclosure is not limited thereto.

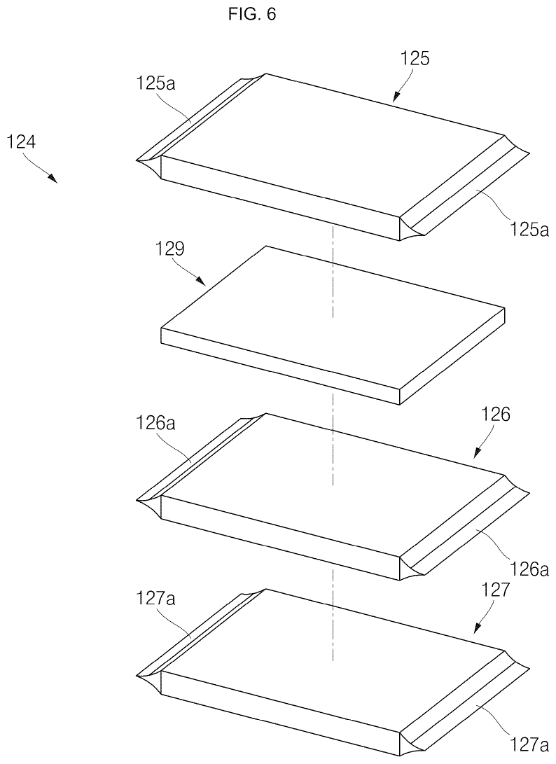

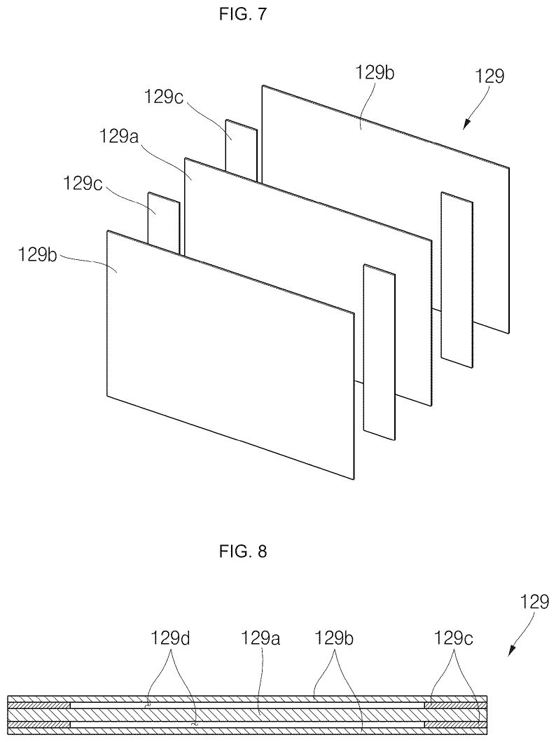

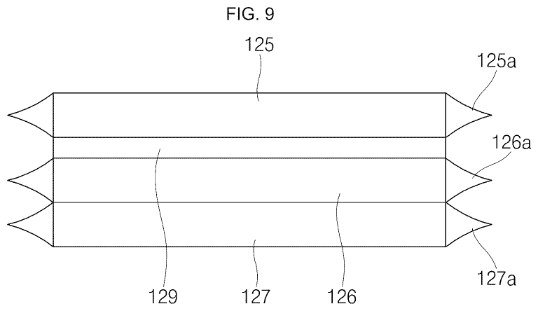

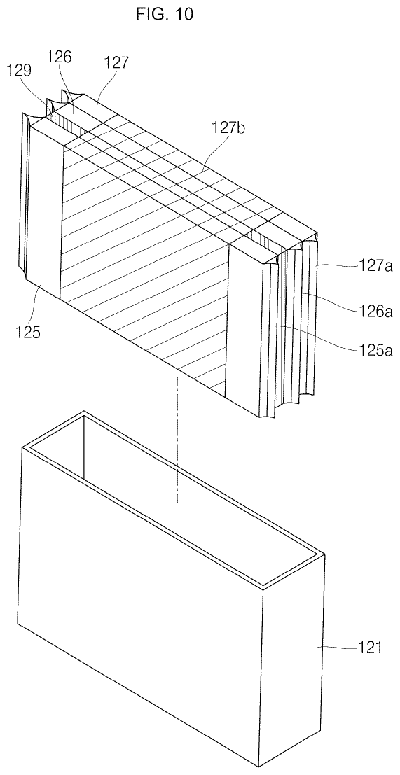

FIG. 6 is a perspective view of the electrode assembly 124 and an extinguishing sheet 129, according to an embodiment, FIG. 7 is an exploded perspective view of the extinguishing sheet 129 according to an embodiment, FIG. 8 is a cross-sectional view of the extinguishing sheet 129 according to an embodiment, FIG. 9 is a front view of the electrode assembly and the extinguishing sheet 129 according to an embodiment, and FIG. 10 is a perspective view of a state in which the electrode assembly and the extinguishing sheet 129 are inserted into the case 121 according to an embodiment.

As illustrated in FIGS. 6 to 10, the electrode assembly 124 may include a plurality of electrode assemblies 124, and the extinguishing sheet 129 may be installed inside the electrode assembly 124.

The electrode assembly 124, according to some embodiments, may be formed by (or may include) a first electrode assembly 125, a second electrode assembly 126, and a third electrode assembly 127. Although an embodiment in which the electrode assembly 124 includes three electrode assemblies is illustrated, the present disclosure is not limited thereto, and the number of electrode assembles 124 may be variously changed.

The first electrode assembly 125 may be provided with a first side tab 125a that is electrically connected to the electrode terminal 122. The first side tab 125a may be provided at each of both sides of the first electrode assembly 125 in the longitudinal direction. The first side tab 125a may be electrically connected to the electrode terminal 122 through the current collector 128.

The second electrode assembly 126 may be provided with a second side tab 126a electrically connected to the electrode terminal 122. The second electrode assembly 126 may be stacked to face the first electrode assembly 125. The second side tab 126a may be provided at each of both sides of the second electrode assembly 126 in the longitudinal direction. The second side tab 126a may be electrically connected to the electrode terminal 122 through the current collector 128.

The third electrode assembly 127 may be provided with a third side tab 127a that is electrically connected to the electrode terminal 122. The third electrode assembly 127 may be stacked to face the second electrode assembly 126. The third side tab 127a may be provided at each of both sides of the third electrode assembly 127 in the longitudinal direction. The third side tab 127a may be electrically connected to the electrode terminal 122 through the current collector 128.

The extinguishing sheet 129 may be stacked between the first electrode assembly 125 and the second electrode assembly 126. In some embodiments, the extinguishing sheet 129 may be stacked between the second electrode assembly 126 and the third electrode assembly 127. In some embodiments, the extinguishing sheet 129 may be stacked between the first electrode assembly 125 and the second electrode assembly 126 and between the second electrode assembly 126 and the third electrode assembly 127.

The second electrode assembly 126 may be stacked at an upper side of the first electrode assembly 125, and the third electrode assembly 127 may be stacked at an upper side of the second electrode assembly 126.

The first electrode assembly 125, the second electrode assembly 126, and the third electrode assembly 127 may be bound (e.g., may be integrally bound) by a binding tape 127b in a state of being stacked together with the extinguishing sheet 129 to be accommodated inside the case 121.

In manufacturing the battery cell 120, the electrode assembly 124 may be stacked in various manners, and the sheet-type extinguishing sheet 129 may be inserted between (or into) the stacked electrode assemblies 124 in any suitable manner. The extinguishing sheet 129 may be made of a chemically resistant and insulating material that is not reactive with the electrolyte.

Before (or when) the electrode assembly 124 is stacked, the extinguishing sheet 129 may be inserted between the electrode assemblies 124 and then manufactured. The extinguishing sheet 129 may be disposed inside the case 121 and be installed at at least one of the inside or outside of the electrode assembly 124 and may be modified into various shapes as long as it can block or impede propagation of fire.

The extinguishing sheet 129 may be installed between the case 121 and the electrode assembly 124 to block or reduce the propagation of the fire. In some embodiments, because the extinguishing sheet 129 is inserted into the inside of the electrode assembly 124, the extinguishing sheet 129 may block or reduce the propagation of the fire occurring inside the electrode assembly 124.

The extinguishing sheet 129, according to some embodiments, may have a panel shape. The extinguishing sheet 129 may be provided in the form of a single plate or may be provided in the form of a plurality of plates. The extinguishing sheet 129, according to some embodiments, may include at least one of flame retardant, nonflammable, or insulating materials.

The extinguishing sheet 129 may further include an extinguishing agent. The extinguishing sheet 129 may be provided as a silicone foam pad, and pores defined inside the extinguishing sheet 129 may be filled with the extinguishing agent.

In some embodiments, if a flame occurs, carbon dioxide gas contained in the extinguishing sheet 129 is released to block or delay propagation of the flame.

One or more selected from the group consisting of inorganic carbonates, inorganic phosphates, and inorganic sulfates may be used as the extinguishing agent, but it is not limited thereto.

In some embodiments, the extinguishing agent used in the extinguishing sheet 129 may be used regardless of whether the extinguishing agent is of the type used for typical fire suppression and regardless of whether the extinguishing agent is powder, a liquid, or a gas. Thus, a variety of known extinguishing agents may be used. For example, the extinguishing agent may be primarily made of ingredients of which production and use are not restricted by the Montreal Protocol, may be a material having excellent extinguishing performance, may be a liquid at room temperature and undergo a phase change at, for example, a temperature in a range of about 100° C. to about 300° C.

The extinguishing agents may include, for example, at least one of fluorine carbon, fluorine chlorine carbon, fluorine bromine carbon, fluorine iodine carbon, or halogenated carbon, such as iodofluorocarbon (also referred to as FIC-21711 or IC-1311).

When the extinguishing agent is contained in the extinguishing sheet 129, the extinguishing agent may be integrated with the sheet-shaped extinguishing sheet 129, and a capsule may be provided inside the extinguishing sheet 129 with the extinguishing agent contained inside the capsule. If a fire occurs, the extinguishing agent contained in the extinguishing sheet 129 may be discharged to extinguish or reduce the fire.

Because the extinguishing sheet 129 is installed inside the electrode assembly 124, the extinguishing sheet 129 may prevent the electrode assembly 124 and the adjacent electrode assembly 124 from contacting (e.g., from directly contacting) each other. The extinguishing sheet 129 may have a planar size corresponding to that of a long side of the facing electrode assembly 124. For example, one side of the extinguishing sheet 129 may face the long side of the first electrode assembly 125, and the other side of the extinguishing sheet 129 may face a long side of the second electrode assembly 126.

The extinguishing sheet 129 may be used by (or may be formed by) mixing the flame retardant or nonflammable sheet, which prevents a fire from propagating, and an insulating sheet, which prevents heat from being transferred. For example, the extinguishing sheet 129 may include a first sheet 129a having heat insulation properties, and two second flame retardant or nonflammable sheets 129b attached to both sides of the first sheet 129a through adhesive members 129c, respectively. As described above, the extinguishing sheet 129 may be provided by stacking the first sheet 129a and the second sheet 129b in multiple layers to improve not only flame retardancy and non-flammability but also to provide a thermal insulation effect. For example, if a temperature of the electrode assembly 124 increases in the presence of the extinguishing sheet 129 in which the plurality of sheets are stacked and flame occurs, the extinguishing sheet 129 may prevent heat or flame from propagating to an adjacent electrode assembly 124.

For example, the first sheet 129a may use ceramic paper, and the second sheet 129b may use mica. In some embodiments, the first sheet 129a may further include aerogel to improve insulation performance. In some embodiments, the first sheet 129a may be ceramic paper of a fire-resistant insulating material including fiber.

In some embodiments, the first sheet 129a may be bio-soluble fiber ceramic paper containing alkaline earth metal and may be an eco-friendly high-temperature refractory insulation material that is harmless to the human body.

In some embodiments, the extinguishing sheet 129 may include an adhesive member 129c. The adhesive member 129c may be interposed between the second sheets 129b, may have a certain width from each of both ends of the first sheet 129a, and may be attached between the first sheet 129a and the second sheet 129b. In some embodiments, the adhesive member 129c may have the same length as each of the first sheet 129a and the second sheet 129b in the longitudinal direction.

In some embodiments, the adhesive member 129c may be made of any suitable adhesive having various adhesive components, such as a general double-sided tape or adhesive, and the adhesive member component is not limited in the present disclosure.

Because the adhesive member 129c is attached at (e.g., is attached only at) both ends of the extinguishing sheet 129, central portions between the first sheet 129a and the second sheet 129b may be spaced apart from each other. As a result, an inner space 129d may be defined between the first sheet 129a and the second sheet 129b. In some embodiments, if the electrode assembly 124 swells, a compression rate of the extinguishing sheet 129 may be reduced due to the inner space 129d in the extinguishing sheet 129.

In some embodiments, the adhesive member 129c may have the same width as each of the first sheet 129a and the second sheet 129b in a width direction. For example, upper and lower ends of the first sheet 129a may adhere to upper and lower ends of the second sheet 129b by the adhesive member 129c, respectively.

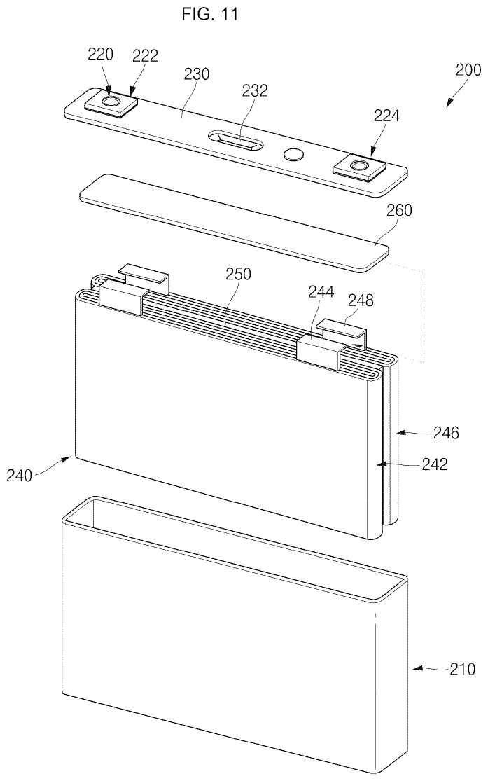

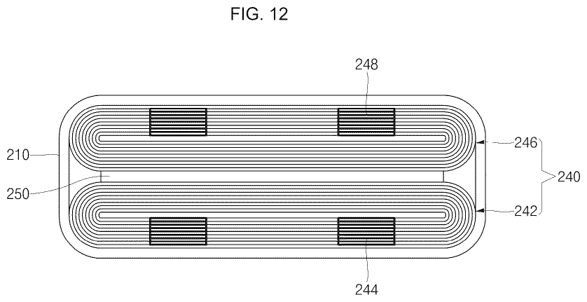

FIG. 11 is an exploded perspective view of a battery cell 200 according to another embodiment, and FIG. 12 is a cross-sectional view of the battery cell 200 shown in FIG. 11. As illustrated in FIGS. 11 and 12, an electrode assembly 240 provided in the battery cell 200 may be installed in a multi-tap manner.

The battery cell 200, according to another embodiment, may include a case 210, an electrode terminal 220, a cap plate 230, an electrode assembly 240, an extinguishing sheet 250, and an insulating plate 260.

The electrode assembly 240 may include a first electrode assembly 242 provided with a first multi-tap 244 electrically connected to the electrode terminal 220 and a second electrode assembly 246 disposed on a side surface of the first electrode assembly 242, which faces the first electrode assembly 242 and is provided with a second multi-tap 248 electrically connected to the electrode terminal 220. The first multi-tap 244 and the second multi-tap 248 may protrude in a direction toward the cap plate 230. The extinguishing sheet 250 may be installed between the first electrode assembly 242 and the second electrode assembly 246.

The case 210 may be made of a conductive metal, such as aluminum, an aluminum alloy, or nickel-plated steel, and may have an approximately hollow hexahedral shape having an opening into which the first electrode assembly 242 and the second electrode assembly 246 may be inserted and seated. The case 210 and the cap plate 230 may installed in a state to be coupled to each other. The cap plate 230 may be provided with a vent 232, which is a passage for gas discharge.

An inner surface of the case 210 may be insulated and, thus, may be insulated from the first electrode assembly 242 and the second electrode assembly 246.

The first electrode assembly 242 may be provided by winding or overlapping a stack of a first electrode plate, a separator, and a second electrode plate, each of which is provided as a thin plate or film. In some embodiments, the first electrode plate may act as a positive electrode, and the second electrode plate may act as a negative electrode. In some embodiments, however, the first electrode plate may act as a negative electrode, and the second electrode plate may act as a positive electrode. In addition, when the first electrode assembly 242 is manufactured in a winding manner, the first electrode assembly 242 may include a first winding center (e.g., first winding tip) at where the winding starts.

The first electrode assembly 242 may include a first multi-tap 244 extending outwardly (or upwardly) and to be electrically connected to the first electrode terminal 222. The first multi-tap 244 may be provided by allowing the non-coating portion of the first electrode assembly 242 to extend/protrude upwardly.

The second electrode assembly 246 may include a second multi-tap 248 extending outwardly (or upwardly) and to be electrically connected to the second electrode terminal 224. The second multi-tap 248 may be provided by allowing the non-coating portion of the second electrode assembly 246 to extend/protrude upwardly.

The second electrode assembly 246 may have substantially the same structure, shape, and/or material as the first electrode assembly 242, described above. Accordingly, a detailed description of the second electrode assembly 246 will be omitted. The second electrode assembly 246 may include a second winding center (e.g., a second winding tip), at where the winding starts, at a center thereof.

An extinguishing sheet 250 may be installed between the first electrode assembly 242 and the second electrode assembly 246. Because the extinguishing sheet 250 is the same or similar to that described above, a repeated detailed description thereof will be omitted. The extinguishing sheet 250 may be installed in a plate shape between the first electrode assembly 242 and the second electrode assembly 246 to prevent or reduce propagation of flame and/or heat.

In some embodiments, each of the first multi-tap 244 and the second multi-tap 248 provided in the first electrode assembly 242 and the second electrode assembly 246 may be directly electrically connected to the electrode terminal 220 to shorten an electrical path. As a result, not only may the internal resistance of the battery cell 200 be reduced but the number of components may also be reduced.

In some embodiments, an insulating plate 260 having a substantially rectangular shape may be installed between the electrode assembly 240 and the cap plate 230. For example, the insulating plate 260 may be made of engineering plastic, such as polyphenylene sulfide (PPS), which has excellent dimensional stability and maintains excellent strength and hardness up to a temperature of approximately 220° C.

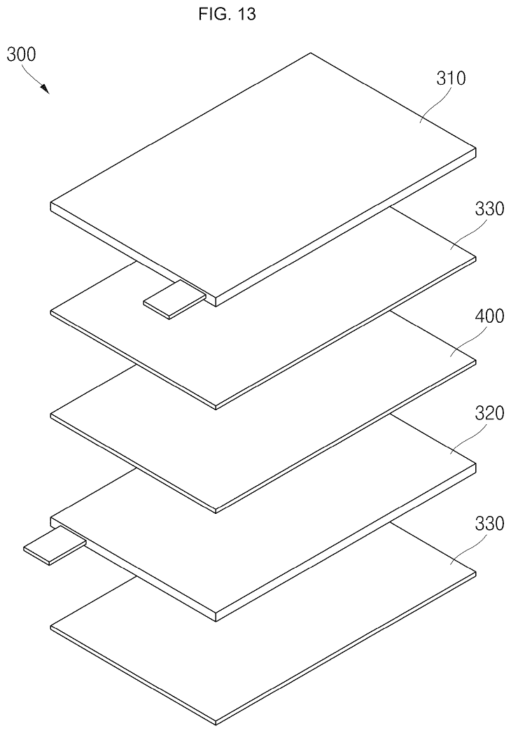

FIG. 13 is a perspective view of a stacked electrode assembly and an extinguishing sheet 400 that is installed within the electrode assembly. As illustrated in FIG. 13, in a stacked electrode assembly 300, a positive electrode plate 310, a negative electrode plate 320, and a separator 330 may be provided in a plate shape and alternately stacked, and the extinguishing sheet 400 may be provided in the shape of a plate and may be stacked to face at least one of the positive electrode plate 310, the negative electrode plate 320, or the separator 330. The extinguishing sheet 250 may be installed to face at least one of the positive electrode plate 310, the negative electrode plate 320, or the separator 330.

As described above, because the extinguishing sheets 129, 250, 400 are installed inside the electrode assembly 124, 240, 300, in the event of the fire, an operating time until which the extinguishing sheet acts (or responds) may be shortened compared to when the extinguishing sheet is installed outside the battery cells 120 and 200 to more quickly block the propagation of the fire.

According to embodiments of the present disclosure, because the extinguishing sheet is installed inside the case of the battery cell, the risk of fire within the battery cell may be reduced and the safety thereof may be improved by reducing or minimizing the propagation of fire between the battery cells if a fire occurs.

However, aspects and features of the present disclosure are not limited to the above-mentioned aspects and features, and other aspects and features not mentioned will be clearly understood by those skilled in the art from the description of the present disclosure provided herein.

As described above, while embodiments of the present disclosure have been described with reference to the drawings, it will be apparent to those skilled in the art that various changes and modifications may be made without departing from the spirit and scope of the present disclosure as defined in the following claims and their equivalents.

What is claimed is:

1. A battery cell comprising:
an electrode assembly comprising a positive electrode plate, a negative electrode plate, and a separator between the positive electrode plate and the negative electrode plate;
a case accommodating the electrode assembly;
a cap plate sealing an opening in the case;
an electrode terminal electrically connected to the electrode assembly and protruding outside of the cap plate; and
an extinguishing sheet inside the case and configured to impede propagation of fire.

2. The battery cell of claim 1, wherein the extinguishing sheet is inserted into the electrode assembly.

3. The battery cell of claim 2, wherein the extinguishing sheet is a panel.

4. The battery cell of claim 2, wherein the electrode assembly comprises:
a first electrode assembly comprising a first side tab electrically connected to the electrode terminal; and
a second electrode assembly stacked on the first electrode assembly and comprising a second side tab electrically connected to the electrode terminal,
wherein the extinguishing sheet is arranged between the first electrode assembly and the second electrode assembly.

5. The battery cell of claim 4, wherein the first side tab is at each of both sides of the first electrode assembly in a longitudinal direction.

6. The battery cell of claim 2, wherein the electrode assembly comprises:
a first electrode assembly comprising a first multi-tab electrically connected to the electrode terminal; and
a second electrode assembly on a side surface of the first electrode assembly facing the first electrode assembly and comprising a second multi-tab electrically connected to the electrode terminal,
wherein the extinguishing sheet is arranged between the first electrode assembly and the second electrode assembly.

7. The battery cell of claim 6, wherein the first multi-tab and the second multi-tab protrude toward the cap plate.

8. The battery cell of claim 2, wherein, in the electrode assembly, the positive electrode plate, the negative electrode plate, and the separator are alternately stacked, and
wherein the extinguishing sheet is a plate and is stacked such that it faces at least one of the positive electrode plate, the negative electrode plate, or the separator.

9. The battery cell of claim 1, wherein the extinguishing sheet comprises at least one of a flame retardant, a nonflammable, or an insulating material.

10. An energy storage module comprising:
a module case having a mounting space therein; and
a plurality of battery cells arranged inside the module case, each of the battery cells comprises:
an electrode assembly comprising a positive electrode plate, a negative electrode plate, and a separator between the positive electrode plate and the negative electrode plate;
a case accommodating the electrode assembly;
a cap plate sealing an opening in the case;
an electrode terminal electrically connected to the electrode assembly and protruding to the outside of the cap plate; and
an extinguishing sheet inside the case and configured to impede propagation of fire.

11. The energy storage module of claim 10, wherein the extinguishing sheet is inserted into the electrode assembly.

12. The energy storage module of claim 11, wherein the electrode assembly comprises:
a first electrode assembly comprising a first side tab electrically connected to the electrode terminal; and
a second electrode assembly stacked on the first electrode assembly and comprising a second side tab electrically connected to the electrode terminal,
wherein the extinguishing sheet is arranged between the first electrode assembly and the second electrode assembly.

13. The energy storage module of claim 12, wherein the first side tab is provided at each of both sides of the first electrode assembly in a longitudinal direction, and
wherein the second side tab is provided at each of both sides of the second electrode assembly in a longitudinal direction.

14. The energy storage module of claim 11, wherein the electrode assembly comprises:
a first electrode assembly comprising a first multi-tab electrically connected to the electrode terminal; and
a second electrode assembly on a side surface of the first electrode assembly facing the first electrode assembly and comprising a second multi-tab electrically connected to the electrode terminal,
wherein the extinguishing sheet is arranged between the first electrode assembly and the second electrode assembly.

15. The energy storage module of claim 14, wherein the first multi-tab and the second multi-tab protrude toward the cap plate.

16. The energy storage module of claim 11, wherein, in the electrode assembly, the positive electrode plate, the negative electrode plate, and the separator are alternately stacked, and
wherein the extinguishing sheet is a plate and faces at least one of the positive electrode plate, the negative electrode plate, or the separator.

17. The energy storage module of claim 10, wherein the extinguishing sheet comprises at least one of a flame retardant, a nonflammable, or an insulating material.

18. The energy storage module of claim 10, wherein the extinguishing sheet is a panel.

19. The energy storage module of claim 17, wherein the extinguishing sheet comprises an extinguishing agent.

20. The energy storage module of claim 19, wherein the extinguishing agent comprises at least one of fluorine carbon, fluorine chlorine carbon, fluorine bromine carbon, fluorine iodine carbon, or halogenated carbon.
